(19) United States
(12) Patent Application Publication
(10) Pub. No.: US 2016/0204662 A1
(43) Pub. Date: Jul. 14, 2016

(54) BRUSHLESS ELECTRIC MOTOR WITH AN OUTER ROTOR

(71) Applicant: MAGNA POWERTRAIN BAD HOMBURG GMBH, Bad Homburg (DE)

(72) Inventors: Elmar Hoppach, Bad Homburg (DE); Tilo Schaefer, Daubach (DE)

(21) Appl. No.: 14/912,458

(22) PCT Filed: Aug. 26, 2014
(86) PCT No.: PCT/EP2014/068087

§ 371 Date: Feb. 17, 2016

(30) Foreign Application Priority Data
Aug. 27, 2013 (DE) 10 2013 109 264.0

(51) Int. Cl. H02K 1/18; H02K 3/52; H02K 1/27; H02K 1/14

(52) U.S. Cl. CPC H02K 1/187; H02K 1/14; H02K 3/521; H02K 1/2786

(57) ABSTRACT

A brushless electric motor with an outer rotor on which permanent magnet elements are arranged, and a stator which has electromagnetic stator poles, wherein the electromagnetic stator poles each have a pole foot, a pole tooth and a pole shoe made of iron materials, and with an insulation layer about the iron elements of the stator poles, and with an electric coil winding which is arranged on the insulation layer, characterized in that the pole shoes have in cross section a free-form rounded portion, preferably in the direction of their end regions, and become narrower running away outward toward the ends at an angle >90° with respect to the pole tooth on the underside of the pole shoe at the location where the insulation layer is applied, wherein the insulation layer on the pole shoe extends on the surface for the coil winding receptacle, that is to say on the basically opposite surface of the insulation layer on the pole shoe, at a right angle with respect to the pole tooth.

### CROSS-REFERENCE TO RELATED APPLICATIONS

This application is a U.S. National Stage of International Application No. PCT/EP2014/068087 filed Aug. 26, 2014 and which claims priority to German Application No. DE102013109264.0 filed Aug. 27, 2013. The entire disclosure of each of the above applications is incorporated herein by reference.

### FIELD

The present disclosure relates to a brushless electric motor with an outer rotor on which permanent magnet elements are arranged, and a stator which has electromagnetic stator poles, wherein the electromagnetic stator poles each have a pole foot, a pole tooth and a pole shoe made of iron materials, and with an insulation coating about the iron elements of the poles, and with an electric coil winding which is arranged on the insulation coating.

### BACKGROUND

Such electric motors are known. For example, the utility model document DE 20 2008 017 892 U1 discloses a stator segment for a stator of an electric motor, wherein this stator segment forms a corresponding stator pole with a pole foot, a pole tooth 13 and a pole shoe 12 which has, on the insulation coating side, a surface which is arranged at a right angle with respect to the pole tooth 13, wherein a corresponding insulation layer is applied to the pole tooth 13 and to the pole foot 12. The pole shoe 12 is formed in a relatively solid manner in its end regions on the right and left.

Such an electromagnetic stator pole or such a stator segment has disadvantages in terms of the outlay on material and the magnetic flux.

### SUMMARY OF THE INVENTION

The object of the present disclosure is therefore to provide an electromagnetic stator pole or a stator segment which does not have these disadvantages.

The object is achieved by means of a brushless electric motor with an outer rotor on which permanent magnet elements are arranged, and a stator which has electromagnetic stator poles, wherein the electromagnetic stator poles each have a pole foot, a pole tooth and a pole shoe made of iron materials, and with an insulation layer about the iron elements of the stator poles, and with an electric coil winding which is arranged on the insulation layer, wherein the pole shoes have in cross section a free-form rounded portion, preferably in the direction of their end regions, and become narrower running away outward toward the ends at an angle >90° with respect to the pole tooth on the underside of the pole shoe at the location where the insulation layer is applied, wherein the insulation layer on the pole shoe extends on the surface for the coil winding receptacle, that is to say on the basically opposite surface of the insulation layer on the pole shoe, at a right angle with respect to the pole tooth.

This provides the advantage of functional separation of the guidance of the positionally accurate winding and the shaping of the magnetic poles, wherein the magnetic flux leakage is reduced by the selection of the free-form rounded portion. As a result, the rotational losses of the electric motor are decisively reduced and the power increased.

Furthermore, an electric motor is preferred in which the rotor has 14 rotor poles and the stator has 12 stator grooves, wherein the electromagnetic poles of the stator have a three-phase winding.

A design of the electric motor which is as compact as possible is also preferred for reducing the gap length and the differential speed.

### DESCRIPTION OF THE DRAWINGS

The invention will now be described with reference to the figures, of which:

FIG. 1 shows a pole shoe or a stator segment from the utility model document mentioned above, according to the prior art, and

FIG. 2 shows the stator pole or stator segment modified according to the invention.

### DETAILED DESCRIPTION

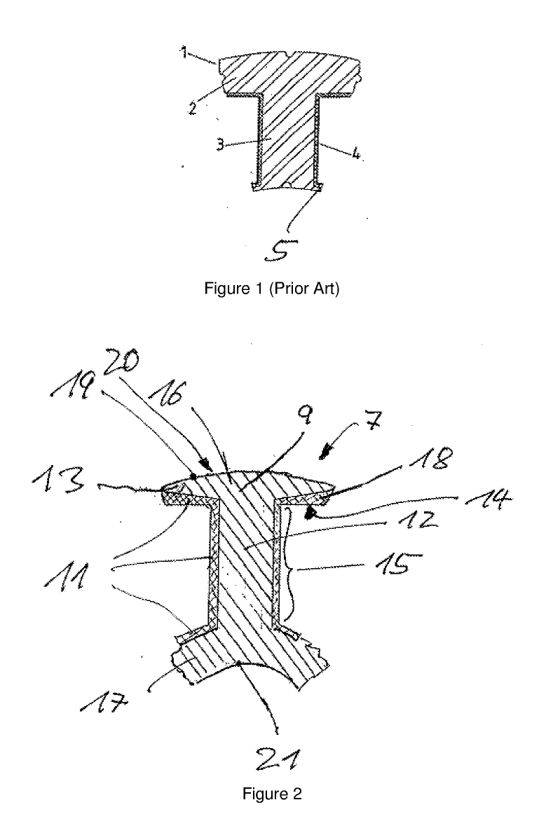

FIG. 1 illustrates a stator segment 1 or an electromagnetic stator pole which has a pole shoe 2, a pole tooth 3, and a pole foot 5. The corresponding pole which is composed of an iron material or a laminated iron core is covered by an insulating coating 4 at the location at which the coil winding will be applied later.

FIG. 2 illustrates a stator segment or an electromagnetic stator pole 7 constructed according to the invention. The stator pole 7 has a stator lamination 9 which is composed of a laminated iron core. The stator lamination 9 made of the iron material is surrounded by an insulation layer 11 in the region in which the electromagnetic coil winding will be applied later, which insulation layer 11 forms an insulating encapsulation by injection molding for guiding the winding. The surface 14 of the insulation extends, in the region in which the winding is applied later, from the insulation layer 11 in the region 15, which insulation layer 11 serves to guide the positionally correct winding on the pole tooth 12, on the underside of the pole shoe 16 at an angle of 90°. The pole shoe 16 itself has a free-form rounded portion 13 at its right-hand and left-hand ends in order to optimize the flow leakage. Since the ends of the iron material extend on the underside of the pole shoe 16 at an angle >90° when viewed from the pole tooth 12, and the ends therefore become thinner and narrower, the region 18 is correspondingly filled in by the insulation layer 11. The corresponding pole shoe 16 is closed with the air gap radius 19 on the air gap side 20 with respect to the rotor which has permanent magnetic poles. On the other side of the pole tooth 12, the pole foot 16 is provided with an inner radius 21 of the stator, which receives the corresponding output shaft of the electric motor and is connected to the outer rotor.

The invention develops a drive which uses a cost-effective stator which can be mass produced. Said stator is optimized in terms of the routing of the grooves for the winding and on a flyer. The functional separation from the guiding of the positionally correct winding and shaping of the magnet poles reduces the rotational losses decisively. The structural configuration of the stator poles 7 reduces flux leakage as a result of the selection of the inner radius 21, and increases the power in the application.

The use of 14 rotor poles with 12 stator grooves and a three-phase winding is advantageous. Reducing the flow losses requires a design which is as compact as possible in order to reduce the gap length and the differential speed.

Further motor geometries can also be used as outer rotors such as, for example 18 rotor poles and 12 stator grooves or 18 rotor poles and 20 stator grooves. However, they entail relatively high expenditure on fabrication.

### LIST OF REFERENCE NUMBERS

1. Stator segment
2. Pole shoe
3. Pole tooth
4. Insulation coating
5. Pole foot
7. Stator pole
9. Stator lamination
11. Insulation layer
12. Pole tooth
13. Free-form rounded portion
14. Surface
15. Region
16. Pole shoe
17. Pole foot
18. Region
19. Air gap radius
20. Air gap side
21. Inner radius

1. A brushless electric motor with an outer rotor on which permanent magnet elements are arranged, and a stator which has electromagnetic stator poles, wherein the electromagnetic stator poles each have a pole foot, a pole tooth and a pole shoe made of iron materials, and with an insulation layer about the iron elements of the stator poles, and with an electric coil winding which is arranged on the insulation layer,
characterized in that the pole shoes have in cross section a free-form rounded portion, preferably in the direction of their end regions, and become narrower running away outward toward the ends at an angle >90° with respect to the pole tooth on the underside of the pole shoe at the location where the insulation layer is applied, wherein the insulation layer on the pole shoe extends on the surface for the coil winding receptacle, that is to say on the basically opposite surface of the insulation layer on the pole shoe, at a right angle with respect to the pole tooth.

2. The electric motor as claimed in claim 1, wherein the electric motor has 14 rotor poles and 12 stator grooves, and wherein the stator has three-phase winding.

3. The electric motor as claimed in claim 1, wherein the stator has a compact design for reducing the gap length.

4. A brushless electric motor including a rotor having permanent magnet elements, a stator having electromagnetic stator poles made of iron materials, an insulation layer surrounding portions of the electromagnetic stator poles to define a coil winding receptacle, and an electric coil winding arranged within the coil winding receptacle defined by the insulation layer, wherein each of the electromagnetic stator poles is configured to include a pole tooth, a pole shoe formed at a first end of the pole tooth, and a pole foot formed at a second end of the pole tooth, the pole shoe having free-form rounded portions at its opposite ends extending outwardly and tapered away from the first end of the pole tooth so as to define an underside surface extending at an angle of greater than 90° relative to the pole tooth, and wherein the insulation layer disposed between the underside surface of the pole shoe and the coil winding receptacle defines a coil guiding surface that is orthogonal relative to an insulation layer surface surrounding the pole tooth.
